(19) United States
(12) Patent Application Publication
(10) Pub. No.: US 2021/0287655 A1
(43) Pub. Date: Sep. 16, 2021

(54) INFORMATION PROCESSING APPARATUS AND INFORMATION PROCESSING METHOD

(71) Applicant: SONY CORPORATION, TOKYO (JP)

(72) Inventors: SHINICHI KAWANO, TOKYO (JP); HIRO IWASE, KANAGAWA (JP); MARI SAITO, KANAGAWA (JP)

(21) Appl. No.: 16/319,501

(22) PCT Filed: Jul. 26, 2017
(86) PCT No.: PCT/JP2017/026961

§ 371 Date: Jan. 22, 2019

(30) Foreign Application Priority Data
Aug. 9, 2016 (JP) 2016-156120

(51) Int. Cl. G10L 13/10; G10L 13/033; G10L 13/04

(52) U.S. Cl. CPC G10L 13/10; G10L 13/04; G10L 13/033

(57) ABSTRACT

This technology relates to an information processing apparatus and an information processing method for increasing the probability of a user's attention being directed to synthesized speech.

The information processing apparatus includes a speech output control part that controls an output form for synthesized speech based on a context in which the synthesized speech obtained by converting a text to speech is output. Alternatively, the information processing apparatus includes a communication part that transmits to another information processing apparatus context data regarding a context in which synthesized speech obtained by converting a text to speech is output, and further receives from the other information processing apparatus speech control data for use in generating the synthesized speech for which an output form is controlled on the basis of the context data; and a speech synthesis part that generates the synthesized speech on the basis of the speech control data. This technology may be applied to a server that controls output of synthesized speech or to a client that outputs the synthesized speech.

### TECHNICAL FIELD

The present technology relates to an information processing apparatus and an information processing method. More particularly, the technology relates to an information processing apparatus and an information processing method suitable for converting text to speech for output.

### BACKGROUND ART

In the case where text is converted to speech for output by TTS (Text to Speech) technology, a monotonous tone of voice or a flat intonation can distract a user's attention. As a result, the user may fail to understand the content of the text.

In order to prevent the user from getting bored of such synthesized speech, measured have been proposed including progressively increasing speaking rate in accordance with elapsed time and randomly changing various parameters other than the speaking rate such as pitch, volume, and voice quality (e.g., see PTL 1).

### CITATION LIST

### Patent Literature

[PTL 1]

JP 1999-161298A

### SUMMARY

### Technical Problem

However, according to the technique described in PTL 1, the parameters of synthesized speech are changed solely in accordance with elapsed time. That means the changes of the parameters are not always effective and may or may not draw the user's attention to the synthesized speech.

Under these circumstances, the present technology is aimed at increasing the probability of the user's attention being directed to the synthesized speech.

### Solution to Problem

According to one aspect of the present technology, there is provided an information processing apparatus including a speech output control part configured to control an output form for synthesized speech on the basis of a context in which the synthesized speech obtained by converting a text to speech is output.

Preferably, in a case where the context satisfies a predetermined condition, the speech output control part can change the output form for the synthesized speech.

Preferably, the change of the output form for the synthesized speech can include changing at least one of a characteristic of the synthesized speech, an effect on the synthesized speech, BGM (Back Ground Music) in the background of the synthesized speech, the text output in the synthesized speech, or an operation of an apparatus for outputting the synthesized speech.

Preferably, the characteristic of the synthesized speech can include at least one of speaking rate, pitch, volume, or intonation. The effect on the synthesized speech can include at least one of repeating of a specific word in the text or insertion of a pause into the synthesized speech.

Preferably, upon detecting a state in which an attention of a user is not directed to the synthesized speech, the speech output control part can change the output form for the synthesized speech.

Preferably, upon detecting a state in which the attention of a user is directed to the synthesized speech following the changing of the output form for the synthesized speech, the speech output control part can return the output form for the synthesized speech to an initial form.

Preferably, in a case where a state in which an amount of change in the characteristic of the synthesized speech is within a predetermined range is continued for at least a predetermined time period, the speech output control part can change the output form for the synthesized speech.

Preferably, the speech output control part can select one of methods of changing the output form for the synthesized speech on the basis of the context.

Preferably, the information processing apparatus can further include a learning part configured to learn reactions of a user to methods of changing the output form for the synthesized speech. The speech output control part can select one of the methods of changing the output form for the synthesized speech on the basis of the result of learning of the reactions by the user.

Preferably, the speech output control part can further control the output form for the synthesized speech on the basis of a characteristic of the text.

Preferably, the speech output control part can change the output form for the synthesized speech in a case where an amount of the characteristic of the text is equal to or larger than a first threshold value, or in a case where the amount of the characteristic of the text is smaller than a second threshold value.

Preferably, the speech output control part can supply another information processing apparatus with speech control data for use in generating the synthesized speech, thereby controlling the output form for the synthesized speech from the other information processing apparatus.

Preferably, the speech output control part can generate the speech control data on the basis of context data regarding the context acquired from the other information processing apparatus.

Preferably, the context data can include at least one of data based on an image captured of the surroundings of a user, data based on speech sound from the surroundings of the user, or data based on biological information regarding the user.

Preferably, the information processing apparatus can further include a context analysis part configured to analyze the context on the basis of the context data.

Preferably, the context can include at least one of a condition of a user, a characteristic of the user, an environment in which the synthesized speech is output, or a characteristic of the synthesized speech.

Preferably, the environment in which the synthesized speech is output can include at least one of a surrounding environment of the user, an apparatus for outputting the synthesized speech, or an application program for outputting the synthesized speech.

Also according to the first aspect of the present technology, there is provided an information processing method including a speech output control step for controlling an output form for synthesized speech on the basis of a context in which the synthesized speech obtained by converting a text to speech is output.

According to a second aspect of the present technology, there is provided an information processing apparatus including a communication part configured to transmit to another information processing apparatus context data regarding a context in which synthesized speech obtained by converting a text to speech is output, the communication part further receiving from the other information processing apparatus speech control data for use in generating the synthesized speech for which an output form is controlled on the basis of the context data, and a speech synthesis part configured to generate the synthesized speech on the basis of the speech control data.

Also according to the second aspect of the present technology, there is provided an information processing method including a communication step for transmitting to another information processing apparatus context data regarding a context in which synthesized speech obtained by converting a text to speech is output, the communication step further receiving from the other information processing apparatus speech control data for use in generating the synthesized speech for which an output form is controlled on the basis of the context data, and a speech synthesis step for generating the synthesized speech on the basis of the speech control data.

Thus according to the first aspect of the present technology, the output form for synthesized speech is controlled on the basis of the context in which the synthesized speech obtained by converting a text to speech is output.

According to the second aspect of the present technology, context data regarding the context in which synthesized speech obtained by converting a text to speech is output is transmitted to another information processing apparatus. Speech control data for use in generating the synthesized speech for which the output form is controlled on the basis of the context data is received from the other information processing apparatus. The synthesized speech is then generated in accordance with the speech control data.

### Advantageous Effect of Invention

According to the first or the second aspect of the present technology, the user's attention is drawn to synthesized speech. Particularly, the first or the second aspect of the present technology increases the probability of drawing the user's attention to the synthesized speech.

Note that the advantageous effect outlined above is not limitative of the present disclosure. Further advantages of the disclosure will become apparent from the ensuing description.

### BRIEF DESCRIPTION OF DRAWINGS

FIG. 1 is a block diagram depicting an embodiment of an information processing system to which the present technology is applied.

FIG. 2 is a block diagram depicting a typical partial configuration of functions implemented by a processor of a client.

FIG. 3 is a view depicting a typical text to be output in synthesized speech.

FIG. 4 is a flowchart explaining a synthesized speech output process.

FIG. 5 is a flowchart explaining a synthesized speech output control process.

FIG. 6 is a flowchart explaining details of a TTS data generation process.

FIG. 7 is a schematic diagram depicting specific examples of TTS data in normal mode and in attention mode.

FIG. 8 is a schematic diagram depicting a specific example of attention mode.

FIG. 9 is a schematic diagram depicting another specific example of attention mode.

FIG. 10 is a schematic diagram depicting another specific example of attention mode.

FIG. 11 is a schematic diagram depicting another specific example of attention mode.

FIG. 12 is a schematic diagram depicting another specific example of attention mode.

FIG. 13 is a schematic diagram depicting another specific example of attention mode.

FIG. 14 is a schematic diagram depicting another specific example of attention mode.

FIG. 15 is a block diagram depicting a typical configuration of a computer.

### DESCRIPTION OF EMBODIMENTS

The preferred modes for implementing the present technology (referred to as the embodiments) are described below. Note that the description is given under the following headings:

### 1. Embodiments

### 2. Variations

### 1. Embodiments

### 1-1. Typical Configuration of the Information Processing System

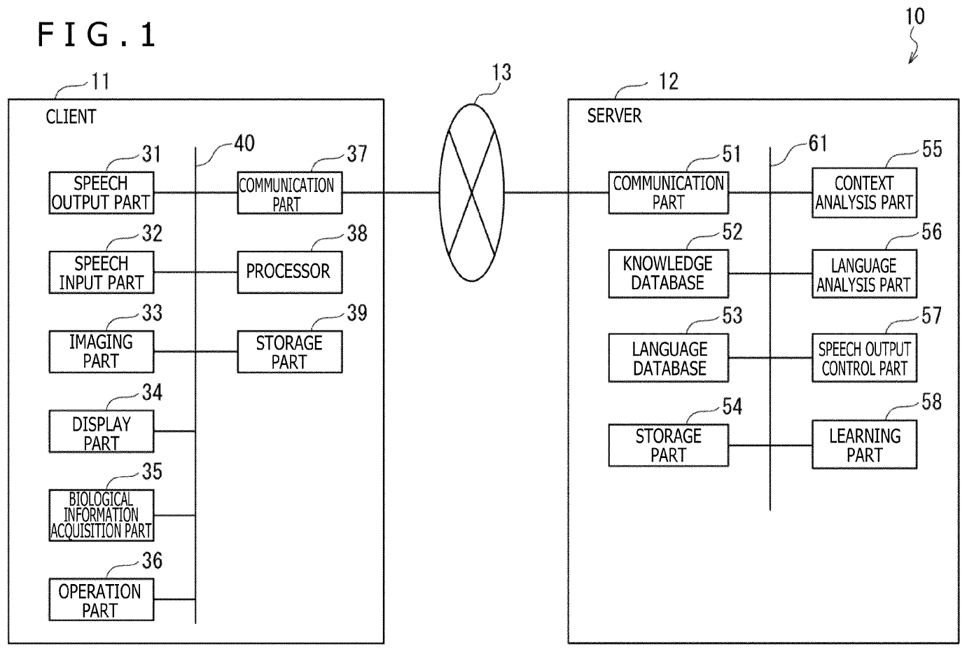

A typical configuration of an information processing system 10 to which the present technology is applied is first explained below with reference to FIG. 1.

The information processing system 10 is a system that converts text to speech for output by TTS technology. The information processing system 10 is configured with a client 11, a server 12, and a network 13. The client 11 and the server 12 are interconnected via the network 13.

Note that, although FIG. 1 depicts only one client 11, multiple clients 11 are connected with the network 13 in practice. Multiple users make use of the information processing system 10 via the clients 11.

Based on TTS data provided by the server 12, the client 11 converts text to speech for output. Here, the TTS data refers to speech control data for use in generating synthesized speech.

For example, the client 11 is configured with a portable information terminal such as a smartphone, a tablet, a cellphone, or a laptop personal computer; a wearable device, a desktop personal computer, a game machine, a video reproduction apparatus, or a music reproduction apparatus, for example. The wearable device may be of various types including, for example, an eyeglass type, a wristwatch type, a bracelet type, a necklace type, a neckband type, an earphone type, a headset type, and a head-mounted type.

The client 11 includes a speech output part 31, a speech input part 32, an imaging part 33, a display part 34, a biological information acquisition part 35, an operation part 36, a communication part 37, a processor 38, and a storage part 39. The speech output part 31, speech input part 32, imaging part 33, display part 34, biological information acquisition part 35, operation part 36, communication part 37, processor 38, and storage part 39 are interconnected via a bus 40.

The speech output part 31 is configured with speakers, for example. The number of speakers may be determined as desired. The speech output part 31 outputs speech based on speech data supplied from the processor 38.

The speech input part 32 is configured with microphones, for example. The number of microphones may be determined as desired. The speech input part 32 collects speech sound from around the user (including the user's speech). The speech input part 32 supplies the speech data representing the collected speech sound to the processor 38 or stores the speech data into the storage part 39.

The imaging part 33 is configured with cameras, for example. The number of cameras may be determined as desired. The imaging part 33 captures images of the user's surroundings (including the user), and supplies image data representing the captured images to the processor 38 or stores the image data into the storage part 39.

The display part 34 is configured with a display, for example. The number of display units may be determined as desired. The display part 34 displays images based on the image data supplied from the processor 38.

The biological information acquisition part 35 is configured with devices and sensors for acquiring various kinds of human biological information. The biological information acquired by the biological information acquisition part 35 includes, for example, data for use in detecting the user's physical condition, degree of concentration, and degree of tension (e.g., heartbeat, pulse rate, amount of perspiration, and body temperature). The biological information acquisition part 35 supplies the acquired biological information to the processor 38 or stores the information into the storage part 39.

The operation part 36 is configured with various types of operating members. The operation part 36 is used to operate the client 11.

The communication part 37 is configured with various types of communication devices. The communication system of the communication part 37 is not limited to any specific system; the communication part 37 may communicate in wired or wireless fashion. The communication part 37 may alternatively support multiple communication systems. The communication part 37 communicates with the server 12 via the network 13. The communication part 37 supplies the data received from the server 12 to the processor 38 or stores the data into the storage part 39.

The processor 38 controls the components of the client 11, and exchanges data with the server 12 via the communication part 37 and network 13. Also, the processor 38 performs speech synthesis based on the TTS data acquired from the server 12 (i.e., performs the process of reproducing TTS data), generates speech data representing the acquired synthesized speech, and supplies the speech data to the speech output part 31.

The storage part 39 stores programs and data necessary for the client 11 to perform its processing.

The server 12 generates TTS data in accordance with requests from the client 11, and transmits the generated TTS data to the client 11 via the network 13. The server 12 includes a communication part 51, a knowledge database 52, a language database 53, a storage part 54, a context analysis part 55, a language analysis part 56, a speech output control part 57, and a learning part 58.

The communication part 51 is configured with various types of communication devices. The communication system of the communication part 51 is not limited to any specific system; the communication part 51 may communicate in wired or wireless fashion. The communication part 51 may alternatively support multiple communication systems. The communication part 51 communicates with the client 11 via the network 13. The communication part 51 supplies the data received from the client 11 to the components inside the server 12 or stores the received data into the storage part 54.

The knowledge database 52 stores data regarding various kinds of knowledge. For example, the knowledge database 52 stores data regarding pieces of BGM music that may play in the background of the synthesized speech based on the TTS data.

The language database 53 stores data regarding various languages. For example, the language database 53 stores data regarding expressions and wording.

The storage part 54 stores programs and data necessary for the server 12 to perform its processing. For example, the storage part 54 stores the text targeted for reproduction using the TTS data provided to the client 11.

The context analysis part 55 carries out a visual line recognition process, an image recognition process, and a speech recognition process on the basis of data acquired from the client 11, for example. In so doing, the context analysis part 55 analyzes the context in which the client 11 outputs synthesized speech. The context analysis part 55 supplies the result of the analysis to the speech output control part 57 and learning part 58 and stores the analysis result into the storage part 54.

Incidentally, the context in which synthesized speech is output includes, for example, the conditions and characteristics of the user as the target for output of the synthesized speech, the environment in which the synthesized speech is output, and the characteristics of the synthesized speech.

The language analysis part 56 analyzes the language of the text to be output in synthesized speech and thereby detects the characteristics of the text, for example. The language analysis part 56 supplies the result of the analysis to the speech output control part 57 and learning part 58 and stores the analysis result into the storage part 54.

The speech output control part 57 generates the TTS data for use by the client 11 based on the data stored in the knowledge database 52 and in the language database 53, on the result of the analysis by the context analysis part 55, on the result of the analysis by the language analysis part 56, and on the result of the learning by the learning part 58. The speech output control part 57 transmits the generated TTS data to the client 11 via the communication part 51.

Also, in accordance with the characteristics of the context and the text, the speech output control part 57 sets the output mode for synthesized speech either to normal mode or to attention mode. Normal mode is a mode in which synthesized speech is output in standard output form. Attention mode is a mode in which synthesized speech is output in an output form different from that of normal mode so as to draw the user's attention to the synthesized speech. The speech output control part 57 generates the TTS data compatible with each of the different output modes and provides the generated TTS data to the client 11 in a manner controlling the client 11 to output the synthesized speech in each output mode.

The learning part 58 learns the characteristics of each user based on the result of the analysis by the context analysis part 55 and on the result of the analysis by the language analysis part 56, for example. The learning part 58 stores the result of the learning into the storage part 54.

Note that, in the description that follows, the wording “via the network 13” will be omitted whenever the client 11 (communication part 37) and the server 12 (communication part 51) are described as communicating with each other via the network 13.

### 1-2. Examples of Part of the Functions Implemented by the Processor of the Client

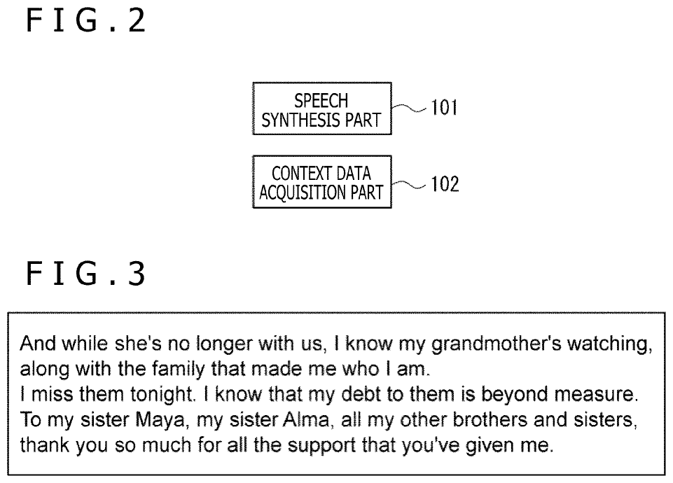

FIG. 2 depicts examples of part of the functions implemented by the processor 38 of the client 11. For example, the processor 38 implements the functions including a speech synthesis part 101 and a context data acquisition part 102 by executing predetermined control programs.

The speech synthesis part 101 performs speech synthesis on the basis of the TTS data acquired from the server 12. The speech synthesis part 101 supplies the speech data representing the acquired synthesized speech to the speech output part 31.

The context data acquisition part 102 acquires data about the context applicable when the synthesized speech is output and, based on the acquired data, generates context data. The context data includes, for example, data based on the speech sound collected by the speech input part 32, data based on the images captured by the imaging part 33, and data based on the biological information acquired by the biological information acquisition part 35.

Here, the data based on the speech sound includes, for example, speech data itself, data representing a characteristic amount extracted from the speech data, and some of the data indicative of the result of analysis of the speech data. The data based on the images includes, for example, image data itself, data representing the characteristic amount extracted from the image data, and some of the data indicating the result of analysis of the image data. The data based on the biological information includes, for example, biological information itself, data representing the characteristic amount extracted from the biological information, and some of the data indicating the result of analysis of the biological information.

The context data acquisition part 102 transmits the generated context data to the server 12 via the communication part 37.

### 1-3. Processes Performed by the Information Processing System 10

The processes performed by the information processing system 10 are explained below with reference to FIGS. 3 to 14. Note that the description below will reference, for example, cases in which the text depicted in FIG. 3 is converted to speech for output. The text is an excerpt from the speech delivered by President Obama in Chicago, Illinoi, of the United States on Nov. 4, 2008.

### Synthesized Speech Output Process

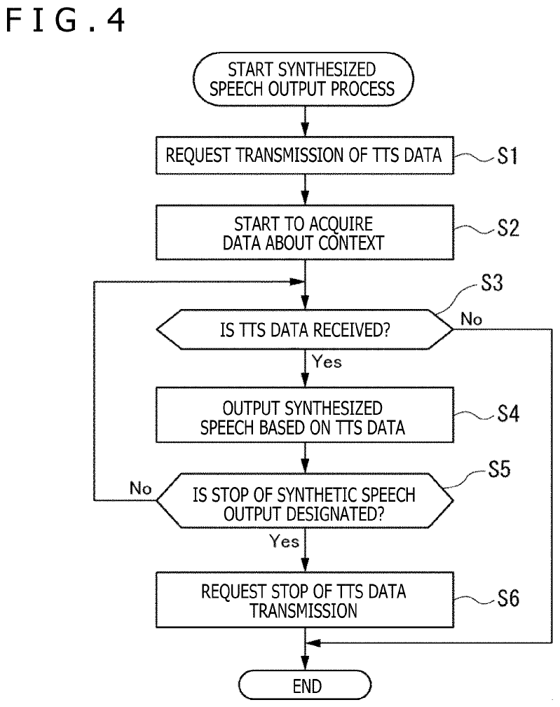

Explained first with reference to the flowchart of FIG. 4 is a synthesized speech output process executed by the client 11. This process is started, for example, when the user operates the operation part 36 of the client 11 to start the output of synthesized speech.

In step S1, the speech synthesis part 101 requests transmission of TTS data. Specifically, the speech synthesis part 101 generates a TTS data transmission request as a command to request transmission of TTS data, and transmits the request to the server 12 via the communication part 37.

The TTS data transmission request includes, for example, the type of the client 11 and of the application program (called the APP hereunder) for use in reproducing the TTS data, and user attribute information. The user attribute information includes, for example, the age, gender, domicile, profession, and nationality of the user. Alternatively, the user attribute information may include, for example, a user ID that uniquely identifies the user and is associated with the user's attribute information held in the server 12.

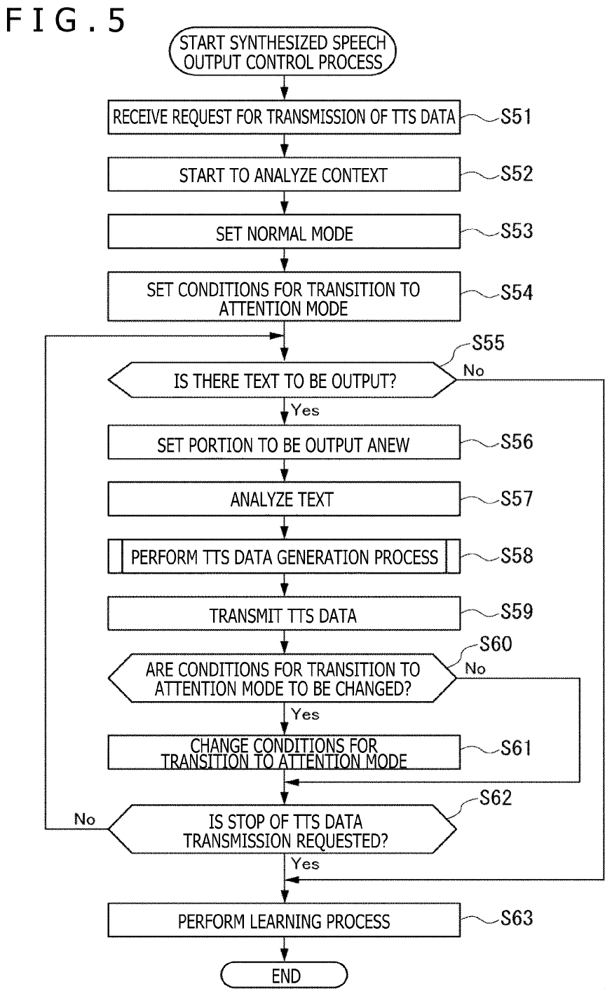

The server 12 receives the TTS data transmission request in step S51 of FIG. 5, to be discussed later. The server 12 transmits the TTS data in step S59 of FIG. 5.

In step S2, the client 11 starts to acquire data about context. Specifically, the speech input part 32 starts the process of collecting speech sound from the user's surroundings and supplying the collected speech data to the context data acquisition part 102. The imaging part 33 starts the process of capturing images of the user's surroundings and supplying the acquired image data to the context data acquisition part 102. The biological information acquisition part 35 starts the process of acquiring the user's biological information and supplying the acquired information to the context data acquisition part 102.

The context data acquisition part 102 starts the process of generating the context data based on the acquired speech data, image data, and biological information and transmitting the generated context data to the server 12 via the communication part 37.

The server 12 receives the context data in step S52 of FIG. 5, to be discussed later.

In step S3, the speech synthesis part 101 discriminate whether or not the TTS data is received. In the case where the TTS data transmitted from the server 12 is received via the communication part 37, the speech synthesis part 101 determines that the TTS data is received. Control is then transferred to step S4.

In step S4, the client 11 outputs synthesized speech based on the TTS data. Specifically, the speech synthesis part 101 performs speech synthesis based on the TTS data, and supplies the speech data representing the acquired synthesized speech to the speech output part 31. The speech output part 31 outputs the synthesized speech based on the speech data.

In step S5, the speech synthesis part 101 discriminates whether or not the output of synthesized speech is designated to be stopped. In the case where it is determined that the stop of the synthesized speech output is not designated, control is returned to step S3.

Thereafter, steps S3 to S5 are repeated until it is determined step S3 that the TTS data is not received or until it is determined in step S5 that the stop of the synthesized speech output is designated.

Meanwhile, in step S5, the speech synthesis part 101 determines that the stop of the synthesized speech output is designated if, for example, the user operates the operation part 36 of the client 11 to stop the synthesized speech output. Control is then transferred to step S6.

In step S6, the speech synthesis part 101 requests that the transmission of the TTS data be stopped. Specifically, the speech synthesis part 101 generates a TTS data transmission stop request as a command to request the stop of the TTS data transmission, and transmits the generated request to the server 12 via the communication part 37.

The server 12 receives the TTS data transmission stop request from the client 11 in step S62 of FIG. 5, to be discussed later.

Thereafter, the synthesized speech output process is brought to an end.

On the other hand, in the case where it is determined in step S3 that the TTS data is not received, the synthesized speech output process is terminated.

### Synthesized Speech Output Control Process

Explained next with reference to the flowchart of FIG. 5 is a synthesized speech output control process performed by the server 12 in conjunction with the synthesized speech output process in FIG. 4.

In step S51, the communication part 51 receives a TTS data transmission request. That is, the communication part 51 receives the TTS data transmission request transmitted from the client 11. The communication part 51 supplies the TTS data transmission request to the context analysis part 55 and to the speech output control part 57.

In step S52, the server 12 starts to analyze the context. Specifically, the communication part 51 starts the process of receiving context data from the client 11 and supplying the received data to the context analysis part 55.

The context analysis part 55 starts to analyze the context on the basis of the TTS data transmission request and the context data.

For example, the context analysis part 55 starts to analyze the user's characteristics based on the user attribute information included in the TTS data transmission request and on the speech data and image data included in the context data. The user's characteristics include, for example, the attributes, preference, competence, and ability to concentrate of the user. The user's attributes include, for example, gender, age, domicile, profession, and nationality.

Also, the context analysis part 55 starts to analyze the user's conditions based on the speech data, image data, and biological information included in the context data. The user's conditions include, for example, direction of visual line, behavior, facial expression, degree of tension, degree of concentration, utterance content, and physical condition.

Furthermore, the context analysis part 55 starts to analyze an environment in which the synthesized speech is output on the basis of information included in the TTS data transmission request regarding the type of the client 11 and of the APP as well as the speech data and image data included in the context data. The environment in which the synthesized speech is output includes, for example, the user's surrounding environment, the client 11 that outputs the synthesized speech, and the APP for outputting the synthesized speech. The user's surrounding environment includes, for example, the user's current position, conditions of people and objects around the user, luminance around the user, and speech sound from around the user.

Also, the context analysis part 55 starts the process of supplying the result of the analysis to the speech output control part 57 and to the learning part 58 and storing the analysis result into the storage part 54.

In step S53, the speech output control part 57 sets normal mode.

In step S54, the server 12 sets the conditions for transition to attention mode. Specifically, the context analysis part 55 estimates, for example, the user's ability to concentrate and the required ability to concentrate.

For example, where the result of learning about the user's past ability to concentrate is stored in the storage part 54, the context analysis part 55 estimates the user's current ability to concentrate based on the learning result.

On the other hand, in the case where the result of learning about the user's past ability to concentrate is not stored in the storage part 54, the context analysis part 55 estimates the user's current ability to concentrate typically on the basis of the user's attributes. For example, the context analysis part 55 estimates the user's ability to concentrate in accordance with the user's age. In the case where the user is a child, for example, the user's ability to concentrate is estimated to be low. As another example, the context analysis part 55 estimates the user's ability to concentrate on the basis of the user's profession. In the case where the user is engaged in a profession that requires a high ability to concentrate, the user's ability to concentrate is estimated to be high.

Further, the context analysis part 55 modifies the result of estimation of the ability to concentrate typically on the basis of the result of analysis of the context. For example, where the user's physical condition is good, the context analysis part 55 modifies the user's ability to concentrate to be higher; where the user's physical condition is poor, the context analysis part 55 modifies the user's ability to concentrate to be lower. As another example, where the user's surroundings constitute an environment that induces the user to concentrate (i.e., a quiet place, or a place with nobody in the vicinity), the context analysis part 55 modifies the user's ability to concentrate to be higher. On the other hand, in the case where the user's surroundings constitute an environment that tends to prevent the user from concentrating (i.e., a noisy place, or a place with people in the vicinity), the context analysis part 55 modifies the user's ability to concentrate to be lower. As a further example, where the APP used by the user handles content associated with the user's high degree of preference (e.g., an APP that deals with the content representing the user's hobby), the context analysis part 55 modifies the user's ability to concentrate to be higher. On the other hand, in the case where the APP used by the user handles content associated with the user's low degree of preference (e.g., an APP for studying for qualifications or for learning academic subjects), the context analysis part 55 modifies the user's ability to concentrate to be lower.

Also, the context analysis part 55 estimates the required ability to concentrate based on the APP used by the user, for example. In the case where the user makes use of a weather forecast APP, for example, the required ability to concentrate is estimated to be low. That is because a high ability to concentrate is not needed to understand the content of the weather forecast and because even if some details are missed, they do not detract much from an overall understanding of the forecast. On the other hand, in the case where the user utilizes an APP for studying for qualifications or for learning academic subjects, the required ability to concentrate is estimated to be high. The reason is that studying and learning require concentration and that missing some details of the speech can increase the possibility of the user failing to understand the content.

The context analysis part 55 supplies the speech output control part 57 with the result of estimation of the user's ability to concentrate and the required ability to concentrate.

The speech output control part 57 sets conditions for transition to attention mode on the basis of the result of estimation of the user's ability to concentrate and the required ability to concentrate. For example, the higher the user's ability to concentrate or the lower the required ability to concentrate, the stricter the conditions set by the speech output control part 57 for transition to attention mode. This makes it more difficult to transition to attention mode. On the other hand, the lower the user's ability to concentrate or the higher the required ability to concentrate, the lower the conditions set by the speech output control part 57 for transition to attention mode. This makes it easier to transition to attention mode.

Alternatively in step S54, the speech output control part 57 may always set standard transition conditions regardless of the user or the context.

In step S55, the speech output control part 57 discriminates whether or not there is a text to be output. For example, in step S55 in a first round, the speech output control part 57 searches the texts in the storage part 54 for the text to be output in synthesized speech (called the output target text hereunder). In the case where the output target text is found, the speech output control part 57 determines that there exists the text to be output. Control is then transferred to step S56.

In the case where there remains any portion of the target output text yet to be output in step S55 in a second or subsequent round, for example, the speech output control part 57 determines that there still exists the text to be output. Control is then transferred to step S56.

In step S56, the speech output control part 57 sets a portion to be output anew. Specifically, the speech output control part 57 sets the portion ranging from the beginning of the non-output portion of the output target text to a predetermined position as the portion to be output anew (this portion will be called the new output portion hereunder). Note that the new output portion is set in units of a sentence, a phrase, or a word.

In step S57, the language analysis part 56 analyzes the text. Specifically, the speech output control part 57 supplies the new output portion of the output target text to the language analysis part 56. The language analysis part 56 performs language analysis of the new output portion. For example, the language analysis part 56 carries out morphological analysis, independent word analysis, compound word analysis, phrase analysis, dependency analysis, and semantic analysis. At this point, the language analysis part 56 may reference, as needed, the already output portion of the output target text or a portion subsequent to the new output portion. This allows the language analysis part 56 to understand the content and characteristic amount of the output target text.

Also, the language analysis part 56 analyzes the degree of difficulty of the output target text based on the result of the analysis. The degree of difficulty of the output target text includes the degree of difficulty of the content and the degree of difficulty of sentences based on the used words and on the lengths of the sentences.

Alternatively, the language analysis part 56 may perform relative evaluation of the degree of difficulty of the output target text in accordance with the user's competence, for example. As another alternative, the language analysis part 56 may perform absolute evaluation of the degree of difficulty of the output target text regardless of the user's competence.

In the case of the relative evaluation above, the degree of difficulty of the text associated with the user's specialty or the user's preferred field is low; the degree of difficulty of the text associated with a field other than the user's specialty or with a field not preferred by the user is high. Also, the degree of difficulty of the text varies depending on the user's age and academic background, for example. Furthermore, the degree of difficulty of the text written in the user's mother tongue is low, and the degree of difficulty of the text in a language different from the user's native language is high, for example.

The language analysis part 56 supplies the result of the analysis to the speech output control part 57 and to the learning part 58.

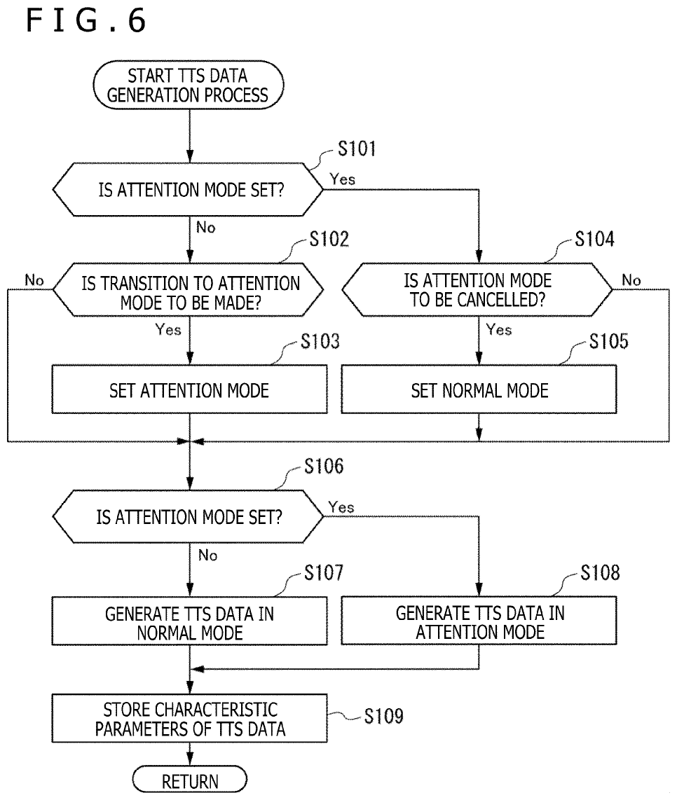

In step S58, the speech output control part 57 performs a TTS data generation process. Details of the TTS data generation process are explained below with reference to the flowchart in FIG. 6.

In step S101, the speech output control part 57 discriminates whether or not attention mode is set. In the case where attention mode is not determined to be set, control is transferred to step S102.

In step S102, the speech output control part 57 discriminates whether or not to transition to attention mode. In the case where the conditions for transition to attention mode are met, the speech output control part 57 determines that transition is to be made to attention mode. Control is then transferred to step S103.

Note that the conditions for transition to attention mode are set on the basis of at least either the context or the text characteristics, for example. The following are typical conditions for transition to attention mode:
The user's attention is not directed to the synthesized speech.
There is little change in the synthesized speech. This constitutes a condition because the user is highly likely to be distracted where the synthesized speech changes little and remains monotonous.
The characteristic amount of the text is large. This constitutes a condition because the text with a large characteristic amount is highly likely to contain a large amount of information or has a high degree of importance, so that it is more necessary for the user to pay attention to the synthesized speech.
The text has a low characteristic amount continuously. This constitutes a condition because the text portion with a low characteristic amount is highly likely to contain a small amount of information or has a low degree of importance, so that the user is more likely to be distracted.

For example, where the user's degree of concentration or degree of tension continues to be lower than a predetermined threshold value for at least a predetermined time period, the speech output control part 57 determines that the user's attention is not directed to the synthesized speech. Alternatively, in the case where the user's attention continues not to be directed to the client 11 for at least a predetermined time period, the speech output control part 57 determines that the user's attention is not directed to the synthesized speech. As another alternative, in the case where the user is found dozing off, the speech output control part 57 determines that the user's attention is not directed to the synthesized speech.

As another example, where the amount of change in each of the parameters (called the characteristic parameters hereunder) representing the characteristics (e.g., speaking rate, pitch, intonation, and volume) of the synthesized speech generated with TTS data continues to fall within a predetermined range for at least a predetermined time period, the speech output control part 57 determines that there is little change in the synthesized speech. Alternatively, in the case where normal mode is continued simply for at least a predetermined time period, the speech output control part 57 determines that there is little change in the synthesized speech.

As another example, where the new output portion of the output target text has a characteristic amount larger than a predetermined first threshold value, the speech output control part 57 determines that the text has a large characteristic amount.

Incidentally, the characteristic amount of the text is increased in the following cases:
Where a noun phrase such as “The glistening snow” is included in a sentence such as “The glistening snow covered the field.”
Where the sentence is an interrogative sentence such as “What are those birds?” that includes words representing 5W1H
Where there is a dependency, as in a sentence “The Thames is the river which flows through London” between “river” and “which flows through London”
Where the speech includes a linguistic representation (modality) indicative of how the speaker judges or feels with respect to the content of the utterance

As a further example, where the new output portion of the output target text has a characteristic amount smaller than a predetermined second threshold value, the speech output control part 57 determines that the text has a small characteristic amount. The second threshold value is set to be smaller than the above-mentioned first threshold value. Alternatively, in the case where the new output portion of the output target text continues to have a characteristic amount smaller than the predetermined second threshold value for at least a predetermined time period, the speech output control part 57 may determine that the text has a small characteristic amount.

Note that the threshold values, predetermined time periods, and ranges of variations mentioned above with respect to the above-described determination conditions are adjusted, for example, in step S54 discussed above and in step S61, to be described below.

The above conditions for transition to attention mode are only examples. These conditions may be supplemented with other conditions or some of them may be eliminated. In the case where multiple transition conditions are used, the transition to attention mode may be made when some of the conditions are met. Alternatively, in the case where at least one of the transition conditions is met, the transition to attention mode may be made.

In step S103, the speech output control part 57 sets attention mode.

Thereafter, control is transferred to step S106.

On the other hand, in the case where the conditions for transition to attention mode are not met in step S102, the speech output control part 57 determines that the transition to attention mode is not to be made. Step S103 is then skipped and, with normal mode left unchanged, control is transferred to step S106.

In the case where it is determined in step S101 that attention mode is being set, control is transferred to step S104.

In step S104, the speech output control part 57 discriminates whether or not attention mode is to be canceled. For example, where the user's attention is detected to be directed to the synthesized speech on the basis of the result of the analysis by the context analysis part 55, the speech output control part 57 determines that attention mode is to be canceled. Control is then transferred to step S105.

The user's attention is directed to the synthesized speech typically in the following cases:
Where the user utters a voice such “Uh?” or “What?” expressing a reaction to attention mode
Where the user's visual line is directed in the direction of the client 11 (e.g., toward the speech output part 31 or the display part 34)

Note that, in the case where the user's attention is not detected to be turned toward the synthesized speech but where attention mode is continued for at least a predetermined time period, the speech output control part 57 determines that attention mode is to be canceled. Control is then transferred to step S105.

In step S105, the speech output control part 57 sets normal mode. The setting cancels attention mode.

Thereafter, control is transferred to step S106.

On the other hand, in step S104, in the case where the user's attention is not detected to be turned toward the synthesized speech and where attention mode has yet to continue for at least a predetermined time period, the speech output control part 57 determines that attention mode is not to be canceled. Step S105 is then skipped and, with attention mode left unchanged, control is transferred to step S106.

In step S106, the speech output control part 57 discriminates whether or not attention mode is being set. If it is determined that attention mode is not set, control is transferred to step S107.

In step S107, the speech output control part 57 generates TTS data in accordance with normal mode. Specifically, the speech output control part 57 generates the TTS data for generating synthesized speech of the new output portion of the output target text. At this point, the speech output control part 57 sets the characteristic parameters such as speaking rate, pitch, intonation, and volume to predetermined default values.

Thereafter, control is transferred to step S109.

On the other hand, in the case where it is determined in step S106 that attention mode is being set, control is transferred to step S108.

In step S108, the speech output control part 57 generates the TTS data in accordance with attention mode. Specifically, the speech output control part 57 generates the TTS data for generating synthesized speech of the new output portion of the output target text. At this point, the speech output control part 57 generates the TTS data in a manner outputting the synthesized speech in an output form different from that of normal mode. This produces changes in the form in which the synthesized speech is output following transition from normal mode to attention mode, thereby drawing the user's attention.

Here are some examples of the methods of changing the output form for synthesized speech. An exemplary method involves changing the characteristics of synthesized speech; another exemplary method involves changing the effects on synthesized speech; a further exemplary method involves changing the BGM against which synthesized speech is output; an even further exemplary method involves changing the text to be output in synthesized speech; and a still further exemplary method involves changing the operation of the client that outputs synthesized speech.

Below is an example of the method of changing the characteristics of synthesized speech.
The characteristics of the synthesized speech such as speaking rate, pitch, volume, and intonation are changed.

Below are examples of the method of changing the effects on synthesized speech.
The synthesized speech is given an echo effect.
The synthesized speech is output in a dissonance.
The settings of the speaker of synthesized speech (e.g., gender, age, and voice quality) are changed.
Pauses are inserted into the synthesized speech. For example, a pause of a predetermined time period is inserted halfway into a noun phrase or after a conjunction.
Particular words in the text being output in synthesized speech are repeated.

Note that, in the case where particular words are repeated, the following settings are made: a maximum number of words to be repeated in the new output portion of the output target text (called the maximum repeat target count hereunder); the words to be repeated (called the repeat target hereunder); the number of times the repeat target is repeated (called the repeat count hereunder); and the method by which to repeat the repeat target (called the repeat method hereunder).

The maximum repeat target count is typically set on the basis of the user, the result of language analysis of the output target text, and the output time of synthesized speech. For example, the maximum repeat target count is set to be up to three in accordance with the number of principal parts of speech in the new output portion of the output target text. Alternatively, the maximum repeat target count is set to be three in the case where the output time in synthesized speech of the new output portion of the output target text is at least 30 seconds. As another alternative, the maximum repeat target count is set to be once every 10 seconds for the new output portion of the output target text.

As another example, where the user is a child under a predetermined age, the maximum repeat target count is set to be infinite. All nouns in the new output portion of the output target text are set as the repeat target. In the case where the user is an elderly person over a predetermined age, the maximum repeat target count is set to be one. In the case where the user is other than a child or an elderly person, the maximum repeat target count is set to be three.

The repeat target is set from among nouns, proper nouns, verbs, and independent words, for example. Alternatively, in the case where pauses are inserted in the synthesized speech, the word immediately after a pause is set as the repeat target.

The repeat count is set, for example, on the basis of the part of speech of the repeat count. For example, where the repeat target includes a noun phrase or a proper noun, the repeat count is set to be three. Alternatively, in the case where the user is a child, the repeat count is set to be two, and where the user is an elderly person, the repeat count is set to be three. Where the user is other than a child or an elderly person, the repeat count is set to be one.

The repeat method is set, for example, as follows:
A pause is inserted before the repeat target.
A word is added after the repeat target. For example, in the case where “Yamada-san” is the repeat target, a postpositional particle, an auxiliary verb, or an interjection is added after “Yamada-san,” such as “Yamada-san dayo” or “Yamada-san ne.”
The repeat target is output with characteristics different from those of the preceding or the following word. For example, the volume of the repeat target is increased, its pitch is raised, or its speaking rate is decreased.

Below are examples of the method of changing the BGM.
The BGM is started or stopped.
The BGM is changed.

Note that, in the case where the BGM is started or changed, a suitable BGM is selected depending on the user's preference and attributes, for example. The songs released by the artists favored by the user or those listened to frequently by the user, for example, may be selected as the BGM. Alternatively, songs corresponding to the user's generation may be selected as the BGM. As another alternative, the songs that were popular in the user's younger days are selected as the BGM. As a further alternative, in the case where the user is a child, the theme songs of popular children-oriented TV programs may be selected as the BGM.

Below are examples of the method of changing the text to be output in synthesized speech.
A choice of words specific to the user is added. For example, if the user is a child, an onomatopoeic word or a mimetic word is added to a noun. For example, given a text such as “Here is a cute dog,” a mimetic word “fluffy” is added so that the text will go, “Here is a fluffy cute dog.” As another example, the volume of the added onomatopoeic word or mimetic word is raised.

Below is an example of the method of changing the operation of the client 11 that outputs synthesized speech.
The body of or an attachment (e.g., a controller) to the client 11 that outputs the synthesized speech is vibrated.

Note that the above-mentioned methods of changing the output form for synthesized speech may be implemented individually or in combination. Also, in a single round of attention mode, the output form changing methods may be switched from one to another, or the parameters for each changing method (e.g., characteristic parameters) may be varied.

Also, the method of changing the output form to be implemented is selected on the basis of context, for example.

For example, in the case where the user's surroundings are noisy, the method of increasing the volume of synthesized speech is selected. Where the user's surroundings are noisy and the user is in conversation with another person, for example, the method of vibrating the client 11 is selected. As another example, where the user's surroundings are quiet but the user is not facing in the direction of the client 11, what is selected is the method of inserting a pause of a predetermined time period when the new output portion of the output target text is output halfway through a noun phrase. For example, where the user is an elementary school pupil, what is selected is the method of setting as the repeat target a portion including a noun in the new output portion of the output target text and reducing the speaking rate for the repeat target.

Alternatively, the method of changing the output form to be implemented is selected on the basis of the result of learning of the user's reactions to different output form changing methods. For example, the more pronounced the user's reaction to a method based on the past learning process, the more preferentially that method is selected. In this manner, an ever-more effective changing method is selected for each user.

As another alternative, the method of changing the output form to be implemented is selected on the basis of the number of times transition has been made to attention mode and the frequency with which such transition has been performed. For example, in the case where the number of times transition has been made to attention mode or the frequency with which transition has been performed is so high that it is difficult to direct the user's attention to the synthesized speech, a method that involves a significant change in the output form is selected to better draw the user's attention.

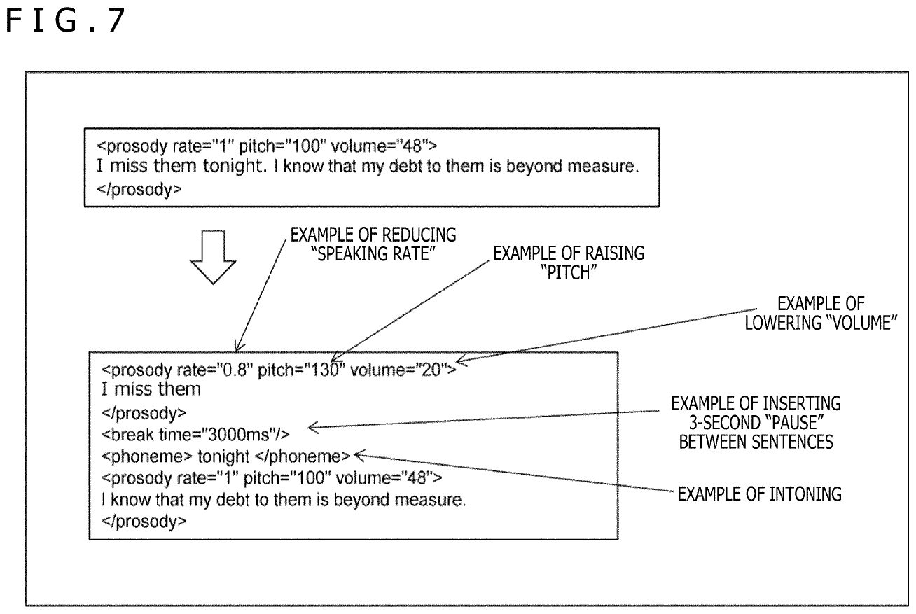

FIG. 7 depicts specific examples of the TTS data in SSLM (Speech Synthesis Markup Language) in both normal mode and attention mode with respect to the portion, “I miss them tonight. I know that my debt to them is beyond measure” in the text in FIG. 3. The upper portion of the drawing presents the TTS data in normal mode, and the lower portion depicts the TTS data in attention mode.

The prosody rate (speaking rate) is set to 1 in normal mode but is lowered to 0.8 in attention mode. The pitch is set to 100 in normal mode but is raised to 130 in attention mode. The volume (of sound) is set to 48 in normal mode but is lowered to 20 in attention mode. A 3000-ms break time is set as the 3-second pause between “I miss them” and “tonight” in attention mode. Also, the phoneme is set to “tonight” to give an intonation.

Incidentally, the purpose of changing the output form for synthesized speech in attention mode is to draw the user's attention to the synthesized speech. Thus it does not matter whether the synthesized speech sounds unnatural or whether the user finds it difficult to catch the synthesized speech.

Thereafter, control is transferred to step S109.

In step S109, the speech output control part 57 stores the characteristic parameters of the TTS data. That is, the speech output control part 57 stores the characteristic parameters including the speaking rate, pitch, intonation, and volume of the new output portion of the generated TTS data into the storage part 54.

Thereafter, the TTS data generation process is brought to an end.

Returning to FIG. 5, in step S59, the speech output control part 57 transmits the TTS data. That is, the speech output control part 57 transmits the TTS data regarding the new output portion of the output target text to the client 11 via the communication part 51.

In step S60, the speech output control part 57 discriminates whether or not the conditions for transition to attention mode are to be changed.

For example, where the error between the user's ability to concentrate estimated in the above-described step S54 and the user's current ability to concentrate is larger than a predetermined threshold value, the speech output control part 57 determines that the conditions for transition to attention mode are to be changed. One reason for the increased error in the user's ability to concentrate is estimated to be a drop in the user's ability to concentrate over time or due to the user's physical condition, for example. Another typical reason is estimated to be the user's preference with regard to the content of the output target text. For example, the higher the user's degree of preference with regard to the content of the output target text, the higher the user's ability to concentrate; the lower the user's degree of preference, the lower the user's ability to concentrate.

As another example, where the error between the required ability to concentrate estimated in the above-described step S54 and the actually required ability to concentrate is larger than a predetermined threshold value, the speech output control part 57 determines that the conditions for transition to attention mode are to be changed. One typical reason for the increased error in the required ability to concentrate is estimated to be a high degree of difficulty of the output target text. For example, the higher the degree of difficulty of the output target text, the higher the required ability to concentrate; the lower the degree of difficulty of the output target text, the lower the required ability to concentrate.

As another example, where the number of times transition has been made to attention mode or the frequency with which such transition has been performed is higher than a predetermined threshold value, the speech output control part 57 determines that the conditions for transition to attention mode are to be changed. Control is then transferred to step S61. That is, frequent transitions to attention mode may give the user a sense of discomfort. This problem may be bypassed, for example, by limiting the maximum number of times the transition can be made to attention mode so as not to transition to attention mode more often than determined, or by lowering over time the conditions for transition to attention mode in order to reduce the frequency of transition.

In the case where it is determined that the conditions for transition to attention mode are to be changed, control is transferred to step S61.

In step S61, the speech output control part 57 changes the conditions for transition to attention mode. For example, the speech output control part 57 again estimates the user's ability to concentrate and the required ability to concentrate and, based on the result of the estimation, again sets the conditions for transition to attention mode.

As a further example, the speech output control part 57 changes the conditions for transition to attention mode on the basis of the number of times the transition has been made to attention mode or the frequency with which the transition has been performed. For example, where the number of times the transition has been made to attention mode exceeds a predetermined threshold value (e.g., 50 times per day), any subsequent transition to attention mode is inhibited.

Thereafter, control is transferred to step S62.

Meanwhile, in the case where it is determined in step S60 that the conditions for transition to attention mode are not to be changed, step S61 is skipped. Control is then transferred to step S62.

In step S62, the speech output control part 57 discriminates whether or not the transmission of the TTS data is requested to be stopped. In the case where it is determined that the TTS data transmission is not requested to be stopped, control is returned to step S55.

Thereafter, steps S55 to S61 are repeated until it is determined in step S55 that there is no more text to be output or until it is determined in step S61 that the TTS data transmission is requested to be stopped.

In the manner described above, the process of generating the TTS data and transmitting the generated TTS data to the client 11 is continued. The TTS data is generated with the transition made to attention mode at the time the conditions for transition to attention mode are met, and with the transition made to normal mode at the time the conditions for canceling attention mode are met.

On the other hand, in the case where the speech output control part 57 fails to find the output target text in step S55 in the first round, the speech output control part 57 determines that there is no text to be output. Control is then transferred to step S63. In the case where the speech output control part 57 does not find the portion yet to be output in the output target text in step S55 in a second or subsequent round, for example, the speech output control part 57 determines that there is no text to be output. Control is then transferred to step S63.

In the case where in step S62 the speech output control part 57 receives via the communication part 51 a TTS data transmission stop request transmitted from the client 11, the speech output control part 57 determines that the TTS data transmission is requested to be stopped. Control is then transferred to step S63.

In step S63, the learning part 58 performs a learning process. For example, the learning part 58 learns the user's ability to concentrate based on a past history of the visual line directions, behavior, degrees of tension, and degrees of concentration of the user during synthesized speech output. The user's ability to concentrate is represented by a high degree of concentration and by the duration of concentration, for example.

Also, the learning part 58 learns the user's preference on the basis of, for example, the characteristics of the output target text and a past history of the visual line directions, facial expressions, behavior, degrees of tension, and degrees of concentration of the user during synthesized speech output. For example, where the user's ability to concentrate was found to be high, the user's degree of preference with regard to the content of the output target text at that time is estimated to be high. On the other hand, in the case where the user's ability to concentrate was found to be low, the user's degree of preference with respect to the content of the output target text at that time is estimated to be low.

Further, the learning part 58 learns the user's reactions to each of the various methods of changing the output form for synthesized speech on the basis of, for example, the presence or absence of the user's reaction at the time of transition to attention mode and the time of the reaction. For example, what is learned here is the probability of the user's reaction to each of the output form changing methods as well as the time to react with each method.

The learning part 58 stores the result of the learning into the storage part 54.

Thereafter, the process of providing the TTS data is brought to an end.

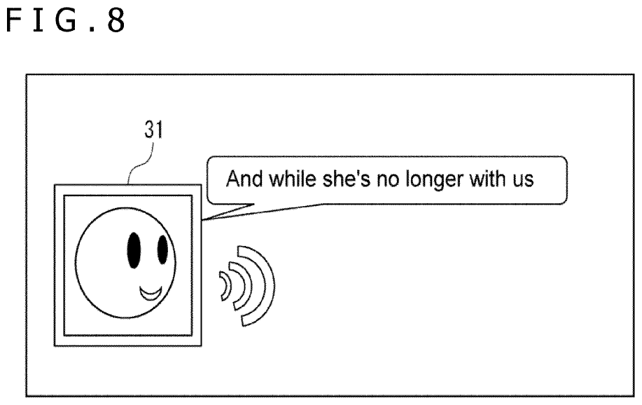

Explained below with reference to FIGS. 8 to 14 are specific images of attention mode for illustration purposes.

First, as illustrated in FIG. 8, the speech output part 31 outputs synthesized speech starting from the beginning of the text in FIG. 3.

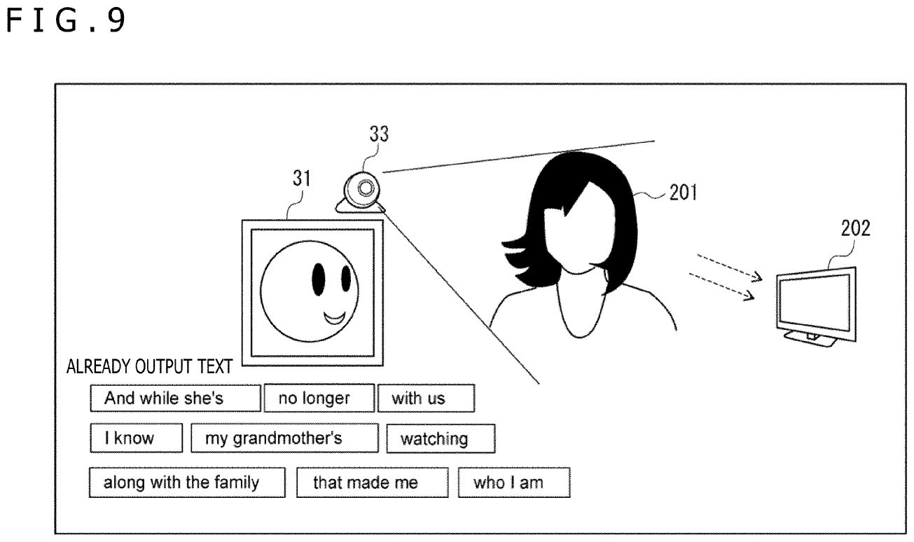

Next as depicted in FIG. 9, suppose that when the synthesized speech output reaches the portion “who I am,” a user 201 shifts his or her attention to a TV program showing on a TV set 202 and faces in the direction of the TV set 201. At this point, the context analysis part 55 of the server 12 detects that the visual line of the user 201 is in the direction of the TV 201 on the basis of image data from the imaging part 33. This causes the speech output control part 57 to change the output mode from normal mode to attention mode.

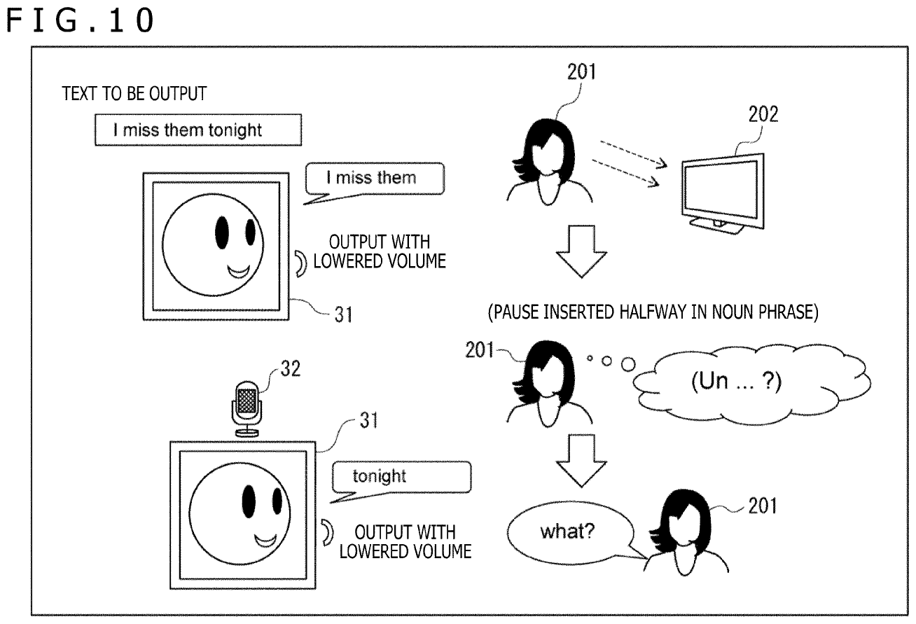

Then as depicted in FIG. 10, the volume of the synthesized speech of the portion “I miss them” in the sentence “I miss them tonight” output from the speech output part 31 is lowered. Further, a predetermined pause is inserted between the noun phrase “them” and the word “tonight” to be output next. When the output form for synthesized speech is varied in this manner, the user 201 feels a sense of discomfort.

Suppose that when the next word “tonight” is output successively at low volume, the user 201 utters “what?” At this point, the context analysis part 55 of the server 12 detects that the user 201 has reacted to attention mode on the basis of speech data from the speech input part 32. As a result, the speech output control part 57 changes the output mode from attention mode back to normal mode.

Next, suppose that when the portion up to “I know that my debt to them is beyond measure” is output in synthesized speech in normal mode, the attention of the user 201 is again shifted to the TV program and the user faces in the direction of the TV 202. As a result, the output mode is again changed from normal mode to attention mode.

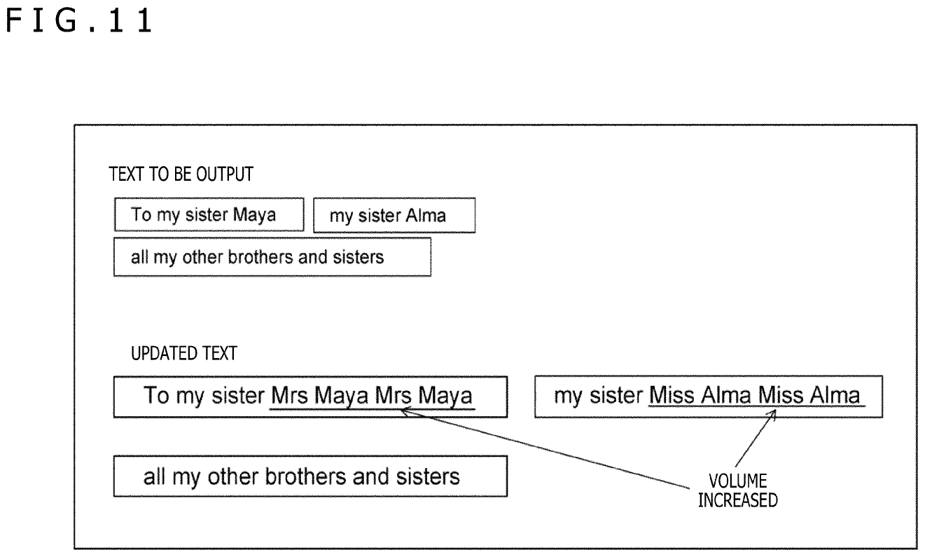

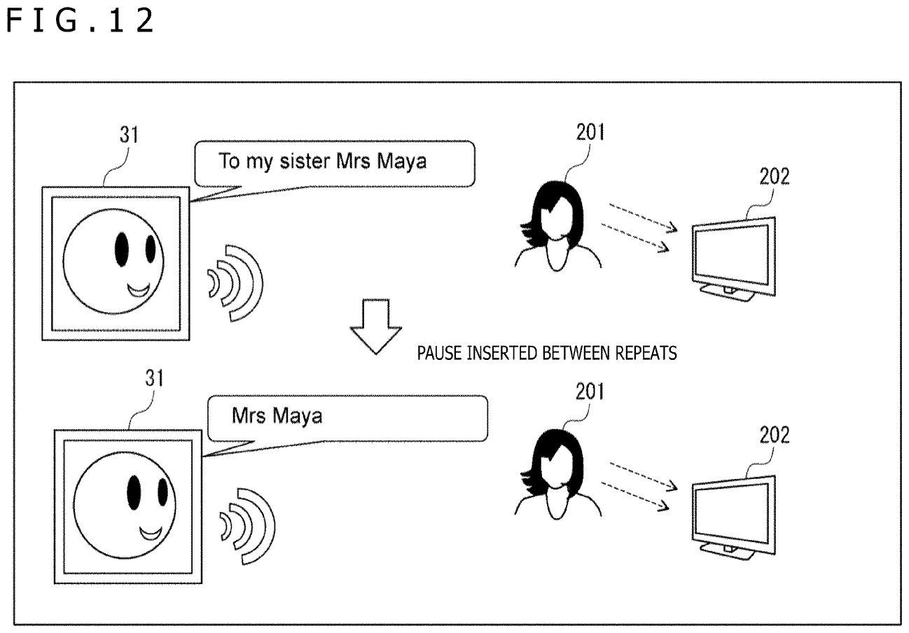

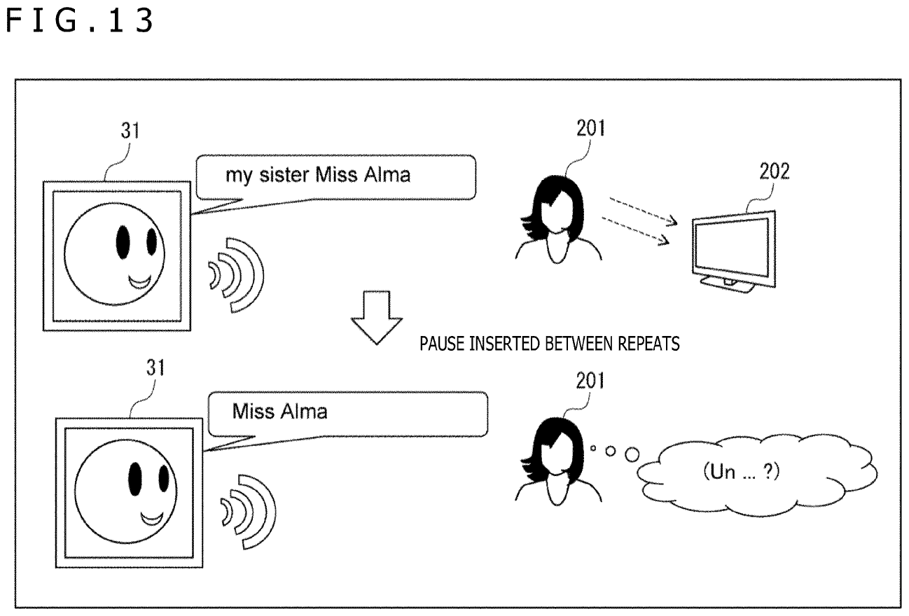

Then as illustrated in FIG. 11, the text to be output is changed, and particular words in the text are repeated. Specifically, “Mrs” is added before “Maya” and “Miss” is added before “Alma.” Also, the portions “Mrs Maya” and “Miss Alma” are repeated twice. Furthermore, the volume of the repeated portions is increased. Also, as depicted in FIG. 12, a predetermined pause is inserted between “Mrs Maya” output for the first time and “Mrs Maya” to be output for the second time. Likewise, as illustrated in FIG. 13, a predetermined pause is inserted between “Miss Alma” output for the first time and “Miss Alma” to be output for the second time. When the output form for synthesized speech is varied in this manner, the user 201 again feels a sense of discomfort.

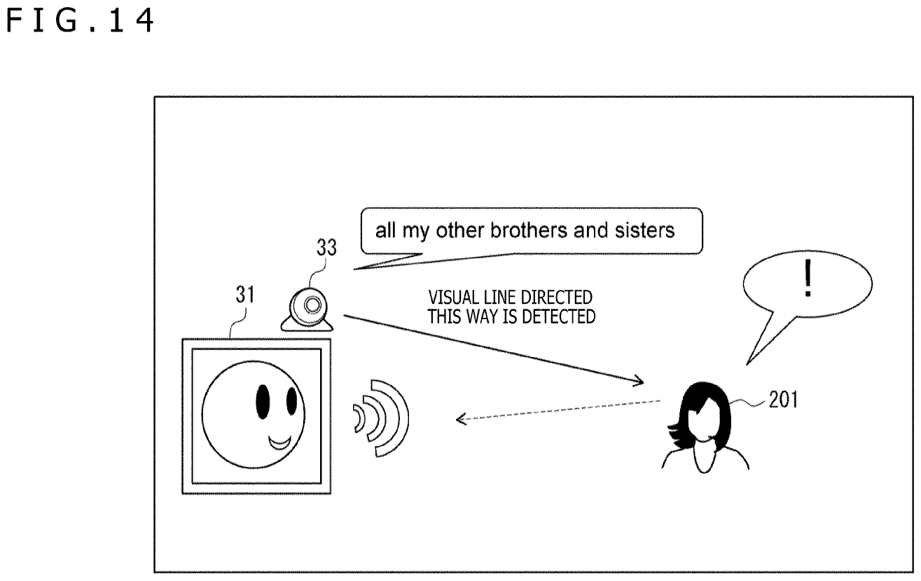

Then as depicted in FIG. 14, suppose that when the portion “all my other brothers and sisters” is output, the visual line of the user 201 is changed from the TV 201 toward the client 11 (speech output part 31). At this point, the context analysis part 55 of the server 12 detects that the visual line of the user 201 is in the direction of the client 11 on the basis of image data from the imaging part 33. This causes the speech output control part 57 to change the output mode from attention mode back to normal mode.

The synthesized speech of the next text is then output in normal mode.

As described above, when the transition is made to attention mode on the basis of, for example, the context and the characteristics of the text so as to output the synthesized speech in an output form different from that of normal mode, the user's attention is aroused, and the possibility of the user' attention being drawn to the synthesized speech is increased.

### 2. Variations

Variations of the embodiments discussed above are explained below.

### 2-1. Variations of the Typical System Configuration

The typical configuration of the information processing system 10 in FIG. 1 is only an example. This configuration may be varied as needed.

For example, part of the functions of the client 11 may be included in the server 12, and part of the functions of the server 12 may be incorporated in the client 11.

As another example, the client 11 and the server 12 may be integrated into a single apparatus that performs the above-described processes.

### 2-2. Other Variations

For example, in normal mode, the speech output control part 57 may acquire TTL data from the storage part 54 or from the outside and transmit the acquired TTL data unmodified to the client 12. In attention mode, the speech output control part 57 may modify the acquired TTL data and transmit the modified TTL data to the client 12 so as to change an output form the synthesized speech.

### 2-3. Configuration Example of a Computer

The series of processes described above may be executed either by hardware or by software. Where the series of processes is to be carried out by software, the programs constituting the software are installed into a suitable computer. Variations of the computer include one with the software installed beforehand in its dedicated hardware, and a general-purpose personal computer or like equipment capable of executing diverse functions based on the programs installed therein.

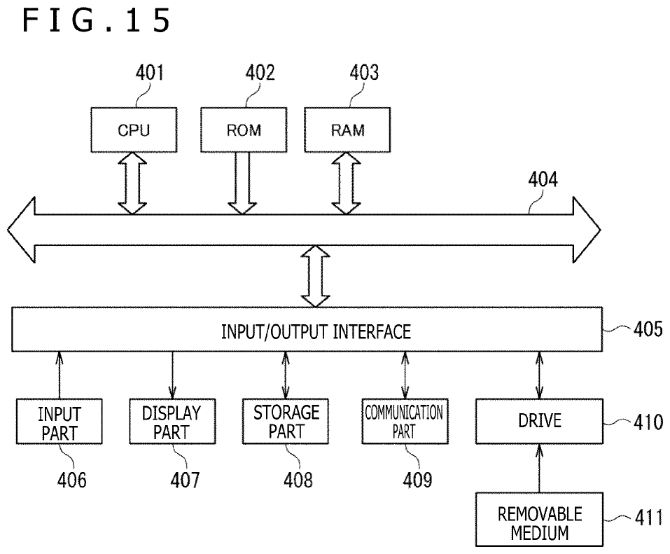

FIG. 15 is a block diagram depicting a typical hardware configuration of a computer that executes the above-described series of processes using programs.

In the computer, a CPU (Central Processing Unit) 401, a ROM (Read Only Memory) 402, and a RAM (Random Access Memory) 403 are interconnected via a bus 404.

The bus 404 is further connected with an input/output interface 405. The input/output interface 405 is connected with an input part 406, an output part 407, a storage part 408, a communication part 409, and a drive 410.

The input part 406 includes a keyboard, a mouse, and a microphone, for example. The output part 407 includes a display unit and speakers, for example. The storage part 408 is typically formed by a hard disk or a nonvolatile memory. The communication part 409 is typically constituted by a network interface. The drive 410 drives removable media 411 such as a magnetic disk, an optical disk, a magneto-optical disk, or a semiconductor memory.

In the computer configured as described above, the CPU 401 performs the above-mentioned series of processes by loading appropriate programs from the storage part 408 into the RAM 403 via the input/output interface 405 and the bus 404 and by executing the loaded programs.

The programs to be executed by the computer (CPU 401) may be recorded on the removable media 411 such as packaged media when offered. The programs may also be offered via wired or wireless transmission media such as local area networks, the Internet, and digital satellite broadcasting.

In the computer, the programs may be installed into the storage part 408 from the removable media 411 attached to the drive 410 via the input/output interface 405. The programs may also be installed into the storage part 408 after being received by the communication part 409 via wired or wireless transmission media. The programs may alternatively be preinstalled in the ROM 402 or in the storage part 408.

Also, each program to be executed by the computer may be processed chronologically, i.e., in the sequence depicted in this description; in parallel with other programs, or in otherwise appropriately timed fashion such as when it is invoked as needed.

Further, multiple computers may coordinate with each other to perform the above-described processing. A single or multiple computers executing the above processing constitute the computer system.

In this description, the term “system” refers to an aggregate of multiple components (e.g., apparatuses or modules (parts)). It does not matter whether or not all components are housed in the same enclosure. Thus a system may be configured with multiple apparatuses housed in separate enclosures and interconnected via a network, or with a single apparatus that houses multiple modules in a single enclosure.

Furthermore, the present technology is not limited to the embodiments discussed above and may be implemented in diverse variations so far as they are within the scope of the appended claims or the equivalents thereof.

For example, the present technology may be implemented as a cloud computing setup in which a single function is processed cooperatively by multiple networked apparatuses on a shared basis.

Also, each of the steps discussed with reference to the above-described flowcharts may be executed either by a single apparatus or by multiple apparatuses on a shared basis.

Furthermore, if a single step includes multiple processes, these processes may be executed either by a single apparatus or by multiple apparatuses on a shared basis.

The advantageous effects stated in this description are only examples and are not limitative of the present technology. There may be other advantageous effects derived from the technology.

The present technology disclosed in the above description may be configured preferably as follows:

(1)

An information processing apparatus including:

a speech output control part configured to control an output form for synthesized speech on a basis of a context in which the synthesized speech obtained by converting a text to speech is output.

(2)

The information processing apparatus as stated in paragraph (1) above, in which, in a case where the context satisfies a predetermined condition, the speech output control part changes the output form for the synthesized speech.

(3)

The information processing apparatus as stated in paragraph (2) above, in which the change of the output form for the synthesized speech includes changing at least one of a characteristic of the synthesized speech, an effect on the synthesized speech, BGM (Back Ground Music) in the background of the synthesized speech, the text output in the synthesized speech, or an operation of an apparatus for outputting the synthesized speech.

(4)

The information processing apparatus as stated in paragraph (3) above,

in which the characteristic of the synthesized speech includes at least one of speaking rate, pitch, volume, or intonation, and the effect on the synthesized speech includes at least one of repeating of a specific word in the text or insertion of a pause into the synthesized speech.

(5)

The information processing apparatus as stated in any one of paragraphs (2) to (4) above, in which, upon detecting a state in which an attention of a user is not directed to the synthesized speech, the speech output control part changes the output form for the synthesized speech.

(6)

The information processing apparatus as stated in any one of paragraphs (2) to (5) above, in which, upon detecting a state in which the attention of a user is directed to the synthesized speech following the changing of the output form for the synthesized speech, the speech output control part returns the output form for the synthesized speech to an initial form.

(7)

The information processing apparatus as stated in any one of paragraphs (2) to (6) above, in which, in a case where a state in which an amount of change in the characteristic of the synthesized speech is within a predetermined range is continued for at least a predetermined time period, the speech output control part changes the output form for the synthesized speech.

(8)

The information processing apparatus as stated in any one of paragraphs (2) to (7) above, in which the speech output control part selects one of methods of changing the output form for the synthesized speech on the basis of the context.

(9)

The information processing apparatus as stated in any one of paragraphs (2) to (8) above, further including:

a learning part configured to learn reactions of a user to methods of changing the output form for the synthesized speech,

in which the speech output control part selects one of the methods of changing the output form for the synthesized speech on a basis of the result of learning of the reactions by the user.

(10)

The information processing apparatus as stated in any one of paragraphs (1) to (9) above, in which the speech output control part further controls the output form for the synthesized speech on a basis of a characteristic of the text.

(11)

The information processing apparatus as stated in paragraph (10) above, in which the speech output control part changes the output form for the synthesized speech in a case where an amount of the characteristic of the text is equal to or larger than a first threshold value, or in a case where the amount of the characteristic of the text is smaller than a second threshold value.

(12)

The information processing apparatus as stated in any one of paragraphs (1) to (11) above, in which the speech output control part supplies another information processing apparatus with speech control data for use in generating the synthesized speech, thereby controlling the output form for the synthesized speech from the other information processing apparatus.

(13)

The information processing apparatus as stated in paragraph (12) above, in which the speech output control part generates the speech control data on a basis of context data regarding the context acquired from the other information processing apparatus.

(14)

The information processing apparatus as stated in paragraph (13) above, in which the context data includes at least one of data based on an image captured of the surroundings of a user, data based on speech sound from the surroundings of the user, or data based on biological information regarding the user.

(15)

The information processing apparatus as stated in paragraph (13) or (14) above, further including:

a context analysis part configured to analyze the context on a basis of the context data.

(16)

The information processing apparatus as stated in any one of paragraphs (1) to (15) above, in which the context includes at least one of a condition of a user, a characteristic of the user, an environment in which the synthesized speech is output, or a characteristic of the synthesized speech.

(17)

The information processing apparatus as stated in paragraph (16) above, in which the environment in which the synthesized speech is output includes at least one of a surrounding environment of the user, an apparatus for outputting the synthesized speech, or an application program for outputting the synthesized speech.

(18)

An information processing method including:

a speech output control step for controlling an output form for synthesized speech on a basis of a context in which the synthesized speech obtained by converting a text to speech is output.

(19)

An information processing apparatus including:

a communication part configured to transmit to another information processing apparatus context data regarding a context in which synthesized speech obtained by converting a text to speech is output, the communication part further receiving from the other information processing apparatus speech control data for use in generating the synthesized speech for which an output form is controlled on a basis of the context data; and

a speech synthesis part configured to generate the synthesized speech on a basis of the speech control data.

(20)

An information processing method including:

a communication step for transmitting to another information processing apparatus context data regarding a context in which synthesized speech obtained by converting a text to speech is output, the communication step further receiving from the other information processing apparatus speech control data for use in generating the synthesized speech for which an output form is controlled on a basis of the context data; and

a speech synthesis step for generating the synthesized speech on a basis of the speech control data.

### REFERENCE SIGNS LIST

10 Information processing system, 11 Client, 12 Server, 31 Speech output part, 32 Speech input part, 33 Imaging part, 34 Display part, 35 Biological information acquisition part, 38 Processor, 55 Context analysis part, 56 Language analysis part, 57 Speech output control part, 58 Learning part, 101 Speech synthesis part, 102 Context data acquisition part

1. An information processing apparatus comprising:
a speech output control part configured to control an output form for synthesized speech on a basis of a context in which the synthesized speech obtained by converting a text to speech is output.

2. The information processing apparatus according to claim 1, wherein, in a case where the context satisfies a predetermined condition, the speech output control part changes the output form for the synthesized speech.

3. The information processing apparatus according to claim 2, wherein the change of the output form for the synthesized speech includes changing at least one of a characteristic of the synthesized speech, an effect on the synthesized speech, BGM (Back Ground Music) in the background of the synthesized speech, the text output in the synthesized speech, or an operation of an apparatus for outputting the synthesized speech.

4. The information processing apparatus according to claim 3,
wherein the characteristic of the synthesized speech includes at least one of speaking rate, pitch, volume, or intonation, and
the effect on the synthesized speech includes at least one of repeating of a specific word in the text or insertion of a pause into the synthesized speech.

5. The information processing apparatus according to claim 2, wherein, upon detecting a state in which an attention of a user is not directed to the synthesized speech, the speech output control part changes the output form for the synthesized speech.

6. The information processing apparatus according to claim 2, wherein, upon detecting a state in which the attention of a user is directed to the synthesized speech following the changing of the output form for the synthesized speech, the speech output control part returns the output form for the synthesized speech to an initial form.

7. The information processing apparatus according to claim 2, wherein, in a case where a state in which an amount of change in the characteristic of the synthesized speech is within a predetermined range is continued for at least a predetermined time period, the speech output control part changes the output form for the synthesized speech.

8. The information processing apparatus according to claim 2, wherein the speech output control part selects one of methods of changing the output form for the synthesized speech on the basis of the context.

9. The information processing apparatus according to claim 2, further comprising:
a learning part configured to learn reactions of a user to methods of changing the output form for the synthesized speech,
wherein the speech output control part selects one of the methods of changing the output form for the synthesized speech on a basis of the result of learning of the reactions by the user.

10. The information processing apparatus according to claim 1, wherein the speech output control part further controls the output form for the synthesized speech on a basis of a characteristic of the text.

11. The information processing apparatus according to claim 10, wherein the speech output control part changes the output form for the synthesized speech in a case where an amount of the characteristic of the text is equal to or larger than a first threshold value, or in a case where the amount of the characteristic of the text is smaller than a second threshold value.

12. The information processing apparatus according to claim 1, wherein the speech output control part supplies another information processing apparatus with speech control data for use in generating the synthesized speech, thereby controlling the output form for the synthesized speech from the other information processing apparatus.

13. The information processing apparatus according to claim 12, wherein the speech output control part generates the speech control data on a basis of context data regarding the context acquired from the other information processing apparatus.

14. The information processing apparatus according to claim 13, wherein the context data includes at least one of data based on an image captured of the surroundings of a user, data based on speech sound from the surroundings of the user, or data based on biological information regarding the user.

15. The information processing apparatus according to claim 13, further comprising:
a context analysis part configured to analyze the context on a basis of the context data.

16. The information processing apparatus according to claim 1, wherein the context includes at least one of a condition of a user, a characteristic of the user, an environment in which the synthesized speech is output, or a characteristic of the synthesized speech.

17. The information processing apparatus according to claim 16, wherein the environment in which the synthesized speech is output includes at least one of a surrounding environment of the user, an apparatus for outputting the synthesized speech, or an application program for outputting the synthesized speech.

18. An information processing method comprising:
a speech output control step for controlling an output form for synthesized speech on a basis of a context in which the synthesized speech obtained by converting a text to speech is output.

19. An information processing apparatus comprising:
a communication part configured to transmit to another information processing apparatus context data regarding a context in which synthesized speech obtained by converting a text to speech is output, the communication part further receiving from the other information processing apparatus speech control data for use in generating the synthesized speech for which an output form is controlled on a basis of the context data; and
a speech synthesis part configured to generate the synthesized speech on a basis of the speech control data.

20. An information processing method comprising:
a communication step for transmitting to another information processing apparatus context data regarding a context in which synthesized speech obtained by converting a text to speech is output, the communication step further receiving from the other information processing apparatus speech control data for use in generating the synthesized speech for which an output form is controlled on a basis of the context data; and
a speech synthesis step for generating the synthesized speech on a basis of the speech control data.
